(19) United States
(12) Patent Application Publication
(10) Pub. No.: US 2011/0048005 A1
(43) Pub. Date: Mar. 3, 2011

(54) Loop geothermal system

(76) Inventor: Timothy Reed McHargue, Danville, CA (US)

(21) Appl. No.: 12/806,849

(22) Filed: Aug. 23, 2010

Related U.S. Application Data
(60) Provisional application No. 61/275,142, filed on Aug. 26, 2009.

(51) Int. Cl. F03G 7/00; F24J 3/08

(52) U.S. Cl. 60/641.3; 165/45

(57) ABSTRACT

One embodiment of a system of geothermal energy production containing a production fluid circulated entirely within a continuous subterranean pipeline (13 and 16) while below the earth's surface (11) so that the production fluid is heated, via the encasing pipe, by surrounding subterranean hot rock (12). By directing the heated production fluid through said continuous subterranean pipeline up to the earth's surface and through a power plant (19), energy can be produced from the hot production fluid.

This system enables energy production from subterranean rock formations of moderate temperature at moderate depths because any production fluid, such as water, hydrocarbon, or refrigerant, can be used to optimize energy production. Furthermore, natural porosity and permeability of the subterranean rock formations at moderate depths may provide sufficient natural circulation of interstitial water to assist in heat transfer from large volumes of hot rock without the need of inducing artificial fractures.

### CROSS-REFERENCE TO RELATED APPLICATIONS

This application claims the benefit of provisional patent application Ser. No. 61/275,142 filed 2009, Aug. 26, by the present inventor.

### FEDERALLY SPONSORED RESEARCH

Not Applicable

### SEQUENCE LISTING OR PROGRAM

Not Applicable

### BACKGROUND

1. Field

This application relates to geothermal energy generation, specifically to the heating of a fluid or gas during transport through subterranean hot rock formations while continuously enclosed within a pipeline formed by intersecting well bores, then delivered to a power plant at the earth's surface, and subsequently re-injected through the pipe back underground in a continuous closed loop.

2. Prior Art

Hot Dry Rock geothermal energy systems rely on the injection of water (U.S. Pat. No. 3,786,858, Potter, Robinson and Smith, 1974) or other fluid (U.S. Pat. No. 4,060,988, Arnold, 1977; U.S. Pat. No. 6,668,554, Brown, 2003) through well bores into subterranean hot rocks and recovery of heated water into other well bores where the water is allowed to return to the earth's surface and convert to steam as pressure decreases (see U.S. Pat. No. 3,786,858, Potter, Robinson and Smith, 1974). The steam is used to drive steam turbines and produce electricity in power plants. The water-injecting well bores are lined with pipes that are perforated near the deepest end of the pipe so as to allow water to escape the pipe and enter the surrounding hot rock. Because of the great depth at which sufficiently hot rocks are encountered, pressure is high and natural permeability of the subterranean rock formations is low. Therefore, the subterranean hot rock formations usually must be artificially fractured. Either water (see U.S. Pat. No. 3,786,858, Potter, Robinson and Smith, 1974) or some other medium (see U.S. Pat. No. 4,254,828, Sowa et al., 1981; U.S. Pat. No. 4,345,652, Roque, 1982) must be forced out of the pipe under pressure sufficient to expand existing rock fractures or create new fractures with sufficient permeability to allow movement of fluid through the surrounding subterranean hot rock. Producing well bores are used to recover hot water, allow it to convert to steam, and deliver it to the power plant at the earth's surface. Problems with this approach to geothermal energy production from hot dry rock are numerous and include:
1. Flow of water from injection well bores to producing well bores usually requires either the expansion of natural fractures or the creation of new fractures. This is expensive, and not always successful because the fractures generated at the injection well bore(s) may not intersect fractures at the producing well bore(s).
2. The generation of fractures in the earth's subsurface may be accompanied by earthquakes which may cause damage at the earth's surface and thereby increase liability and complicate permitting. Further, the risk of earthquakes is increased by introducing water or other fluid, which may serve as a lubricant, into the fractures.
3. Hot water that travels through subterranean rock at high temperature interacts chemically with the subterranean rock and dissolves some mineral components of the subterranean rock. As the water or steam travel to the earth's surface and through a power plant, the dissolved mineral components can come out of solution as water temperature decreases. The deposited mineral components may coat and eventually clog pipes unless remedial actions are taken to prevent it. The remedial actions add to the cost of the produced energy.
4. Steam is derived from water produced from subterranean hot rock formations. In order for sufficient steam to be generated, significant volumes of very hot water must be produced from subterranean rock at high temperatures. Subterranean rock of this high temperature typically is found at great depth and at high pressures where porosity and permeability are small.
5. Fluids other than water can be injected into the subterranean hot rock formations but options are limited due to considerations of chemical interaction with the subterranean hot rock formations and potential pollution of aquifers.

U.S. Pat. No. 4,458,767 (G. L Hoehn, 1984) described a method for intersecting one well bore with a second well bore for application to the petroleum, pipeline and construction industries. U.S. Pat. No. 7,251,938 (Bond, 2007) described a network of intersecting well bores connected to a geothermal power plant located deep below ground. By intersecting two or more bore holes to create a continuous bored path, an uninterrupted closed loop can be created to circulate fluid or gas within pipe through subterranean hot rock formations to a power plant on the earth's surface, and then cycled back through the subterranean hot rock formations again. Considerable expense is saved by locating the power plant on the earth's surface. A continuous subterranean pipeline is created by cementing pipe within the entire bored path from the earth's surface location of one well bore, the injection wellhead, through the earth's subsurface and up to the earth's surface location of the second well bore, the production wellhead. The continuous subterranean pipeline provides the opportunity to transport fluids or gas, here referred to as production fluid, from said injection wellhead through subterranean hot rock formations where the production fluid is heated within the pipeline, and then up through the pipeline to said production wellhead and on to the power plant. Production fluid is contained within pipe along the full path. Several benefits are gained by containing production fluid within pipe along the entire path through subterranean rock formations:
1. The uncertainty of encountering or generating a permeable pathway between injection and production well bores is resolved because they intersect and are directly connected by pipe.
2. Fracturing of the subterranean rock formations can still be performed if desired during the course of drilling one or both of the intersecting well bores. Because the interstitial fluids within the subterranean hot rock are not harvested, the volume and flow rate of the interstitial fluid are less critical. Furthermore, the interstitial fluids remain available to conduct heat to the well bores.
3. Because circulating production fluid never comes in direct contact with subterranean rock formations, being separated from the subterranean hot rock formations by pipe, there is no opportunity for the production fluid to interact chemically with the subterranean hot rock. Therefore, pipes will not clog due to mineral deposition and groundwater systems will not be contaminated by production fluid.
4. Because circulating production fluid never leaves the encasing pipe while in the earth's subsurface, or come in direct contact with subterranean hot rock formations, almost any production fluid and gas can be used as desired to circulate through the Loop Geothermal System in order to optimize the thermal properties of the production fluid to the local thermal conditions of the earth's subsurface and the requirements of a connected power plant.
5. Because the production fluid is entirely and continuously contained within a pipeline system, the production fluid can quickly and easily be changed as needed in response to changing temperature in the subterranean hot rock or changing conditions within the power plant.
6. Because production fluids other than water, such as refrigerants or hydrocarbon liquids and gases, can be circulated within the Loop Geothermal System, the temperature necessary for energy production may be much lower than with water. The lower threshold temperature allows drilling to shallower depths where porosity and permeability are relatively high and interstitial pore water within the subterranean hot rock formations can effectively conduct heat, thus avoiding the necessity to hydraulically fracture the subterranean rock formation.
7. Energy can be produced efficiently by a power plant at the earth's surface without the need to link the Loop Geothermal System to an expensive and unnecessary subterranean power plant.

### DETAILED DESCRIPTION

A novel approach to recovering hot fluid and/or gas for use in geothermal power generation is described here and called a Loop Geothermal System. The novel approach is to circulate fluid or gas, here referred to as production fluid, through subterranean hot rock formations via a continuous subterranean pipeline formed by cementing continuous pipe along the path made by the intersection of two or more separate bore holes. Drilling intersecting well bores and construction of a continuous subterranean pipeline through the intersected well bores is an accepted practice in the petroleum industry and can be contracted commercially, for example SperryConnect Well Intersection Service, a subsidiary of Halliburton. Application of this technology to the geothermal industry is novel and offers several distinct advantages over standard procedures that rely on water flow through subterranean fractures, for example U.S. Pat. No. 3,786,858 to R. M. Potter, E. S. Robinson, and M. C. Smith (1974) and U.S. Pat. No. 5,685,362 to D. W. Brown (1997).

In this embodiment, intersecting boreholes are lined with a continuous pipe that contains the production fluid throughout its circulation in the earth's subsurface and prevents the production fluid from directly contacting or chemically interacting with the subterranean hot rock formations. This continuous subterranean pipeline system provides a continuous pathway for fluid flow and allows heat to transfer from the subterranean hot rock to the pipe and then to the production fluid as it contacts the hot pipe. Delivery of the hot production fluid to a power plant located on the earth's surface provides the opportunity to generate electricity.

A novel aspect of this embodiment is the opportunity it affords to use a wide variety of potential fluids as the production fluid as well as the ability to rapidly and easily change production fluids as subterranean temperatures change or as conditions in the power plant change. The user has the option to use fluids or gasses other than water as production fluids in order to optimize the thermal properties of the production fluid to the local thermal conditions of the earth's subsurface, and the thermal requirements of the power plant. For example, one may choose to utilize supercritical fluids (U.S. Pat. No. 6,668,554 by D. W. Brown, 2003) or any hydrocarbon or refrigerant as the production fluid to feed a power plant. The potential to use fluids or gasses other than water as the production fluid will save money by providing the potential to drill cooler subterranean rocks at shallower depths where porosity and permeability are higher, and by reducing the need to artificially fracture the subterranean rock formations.

### DRAWINGS—FIGURES

FIG. 1 is a schematic representation of one embodiment. All portions of FIG. 1 that are above ground are industry standard facilities shown in simplified schematic form.

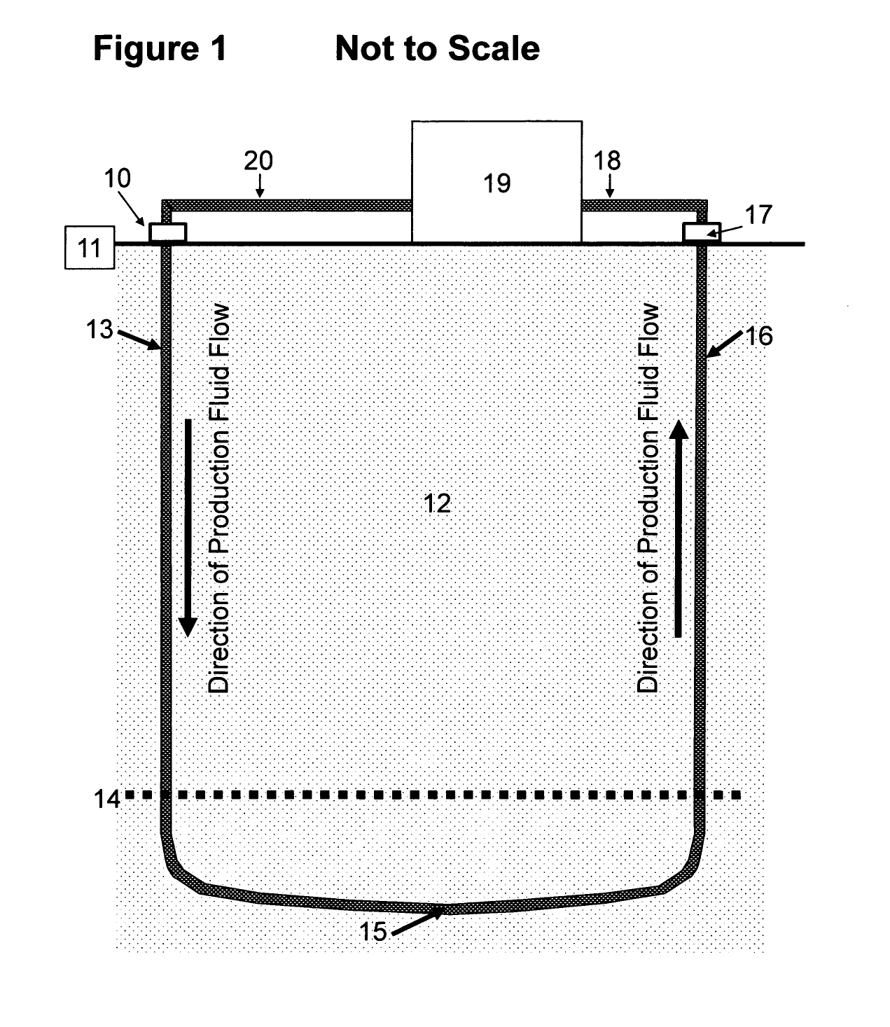

### DRAWINGS—REFERENCE NUMERALS

10 injection wellhead
11 earth's surface
12 subterranean rock formations
13 subterranean descending well bore with contained pipeline
14 subterranean depth of temperature threshold
15 point of intersection of two or more well bores
16 subterranean ascending well bore with contained pipeline
17 production wellhead
18 production fluid delivery pipeline
19 power plant
20 power plant effluent pipeline

### OPERATION

Facilities and operation on the earth's surface (11) for this embodiment utilize geothermal industry standard equipment and operation. The novel aspect of the embodiment, compared to standard geothermal industry practice, is in the type of production fluid used combined with the way in which production fluid passes through subterranean hot rock formations (12). Through two or more intersecting subterranean well bores (13 and 16), a continuous subterranean pipeline is constructed by cementing a continuous string of pipe within and throughout the length of the connected well bores. Said subterranean pipeline follows a path that extends from the injection wellhead (10) of one bore hole, down the path of the subterranean descending well bore with contained pipeline (13) to a depth below the earth's surface that is below a subterranean depth of temperature threshold (14), referred to subsequently as SDTT. From this point, the trajectory of the borehole and said subterranean pipeline becomes nearly horizontal so as to maximize the length of said subterranean pipeline that is located below the SDTT. This segment of said subterranean pipeline includes a point of intersection (15) with a second well bore. Thence said subterranean pipeline continues back up the path of the subterranean ascending well bore with contained pipeline (16) to its production wellhead (17) at the earth's surface (11). The pipeline continues from the production wellhead (17) as a production fluid delivery pipeline (18) to a power plant (19), where energy is produced. Thence, a power plant effluent pipeline (20) returns to the injection wellhead (10) to complete the closed pipeline circuit. Although novel to the geothermal industry, the construction of such a pipeline is an established practice in the petroleum industry. A technique for intersecting two well bores is described in U.S. Pat. No. 4,458,767 by G. L Hoehn, 1984. Drilling of the intersecting well bores and construction of a continuous subterranean pipeline through the intersected well bores can be contracted commercially, for example SperryConnect Well Intersection Service, a subsidiary of Halliburton.

The intersecting well bores can be highly inclined at their lower parts and drilled so that they penetrate the subterranean rock formations for a substantial distance at a depth below SDTT (14) appropriate for heating transported fluid or gas, here referred to as production fluid, to a temperature necessary for commercial geothermal energy production. The depth of the SDTT (14) is dependent upon what production fluid is used. The intersecting well bores continue at a nearly horizontal orientation below the SDTT (14) for a distance calculated to be optimal for exposing the well bore to a maximum length of subterranean hot rock relative to cost. The subterranean hot rock causes the contained production fluid to heat to the desired temperature or convert to gas, then, after the point of intersection (15) of the original two well bores, ascend to the earth's surface at the production wellhead.

During operation, an appropriate production fluid, perhaps water, some other fluid, or gas, is injected at the injection wellhead (10), pumped as needed down the subterranean descending well bore with contained pipeline (13), to a depth below the SDTT (14) where the production fluid is heated due to contact with pipe that has a temperature equilibrated with the surrounding subterranean hot rock. As the production fluid continues along the path of the pipeline, it continues to heat until it ascends through the subterranean ascending well bore with contained pipeline (16) to the production wellhead (17) where the hot production fluid is produced and delivered via the production fluid delivery pipeline (18) to the power plant (19). After energy generation, the effluent production fluid is transported via the power plant effluent pipeline (20) to the injection wellhead (10) and cycled through the earth's subsurface again.

A novel aspect of this embodiment is the opportunity it affords to use a wide variety of potential fluids as the production fluid as well as the ability to rapidly and easily change production fluids as subterranean temperatures change. Production fluids can include, among other options, refrigerants or hydrocarbons. Variables that will impact the economics will include, among other things, the type of production fluid circulated through the subterranean pipeline, the temperature of the equilibrated pipe, the length of the pipeline through subterranean rocks that exceed the SDTT, the natural porosity and permeability of the host subterranean hot rock, and, if needed, the cost of inducing fractures in the host subterranean hot rock. Because fluids or gasses other than water can be used as the production fluid, shallower, cooler host subterranean rocks may be adequate to achieve economically attractive temperatures for power generation without the need to induce fracturing of the host subterranean rock because shallower subterranean rocks tend to have higher natural porosity and permeability values. Also, because no interstitial pore water is produced from the host subterranean hot rock, the interstitial pore water contributes to conducting heat to the pipe without depleting the volume of interstitial pore water. For example, if a liquid hydrocarbon is used as a production fluid, it will convert to gas to power a turbine at a lower temperature than water converts to steam, thus providing the opportunity to generate economically attractive volumes of power from shallower well bores without the need to induce fracturing.

I claim:

1. A method of extracting energy from subterranean hot rock formations comprising:
a. providing two or more bore holes that intersect at a depth where subterranean rock temperatures are greater than a desired calculated temperature threshold,
b. providing a continuous string of pipe cemented within the connected boreholes so that an uninterrupted subterranean pipeline is constructed from the injection wellhead through the earth's subsurface to one or more production wellheads of one or more intersecting well bores,
c. providing a means for fluid or gas, here referred to as production fluid, to be introduced into said subterranean pipeline at one injector wellhead and caused to flow through said subterranean pipeline for the length of said subterranean pipeline and to be contained by said subterranean pipeline until recovered at a production wellhead as either fluid or gas,
d. providing the transfer of heat from subterranean hot rock formations via the hot pipe of said subterranean pipeline to said production fluid without direct contact of said production fluid with subterranean hot rock formations,
e. providing means for producing energy from said production fluid in a power plant at the earth's surface, extracting heat from the production fluid having an increased heat content,
f. providing effluent production fluid or gas from said power plant to be reinjected at the injection wellhead into said subterranean pipeline to be reheated by subterranean hot rock formations while within said subterranean pipeline.

2. The method as recited in claim 1 wherein heat is extracted from the heated production fluid using a power generation system in a power plant at the earth's surface.

3. The method as recited in claim 2 wherein the heated production fluid is expanded directly into a turbine power generator.

4. The method as recited in claim 2 wherein the heated production fluid is conducted through a heat exchanger, thereby transferring heat to a turbine power generator working fluid.

5. The method as recited in claim 3 further comprising injecting the production fluid from the turbine power generator back into said subterranean pipeline.

6. The method as recited in claim 3 wherein the production fluid consists of hydrocarbon compounds.

7. The method as recited in claim 3 wherein the production fluid consists of refrigerant.
